(19) United States
(12) Patent Application Publication
(10) Pub. No.: US 2007/0161117 A1
(43) Pub. Date: Jul. 12, 2007

(54) Method and system for reducing total sample complexity

(76) Inventors: Johan Axelman, Uppsala (SE); Anders Ljunglof, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/587,416

(22) PCT Filed: Jan. 26, 2005
(86) PCT No.: PCT/SE05/00085

§ 371 Date: Jul. 27, 2006

(30) Foreign Application Priority Data
Jan. 29, 2004 (SE) 0400197-0

(51) Int. Cl. G01N 24/00; G01N 1/18

(52) U.S. Cl. 436/173; 436/178

(57) ABSTRACT

The present invention relates to a method for reducing total sample complexity in native or digested biological sample(s), before analysis thereof by mass spectrometry, comprising the following steps: a) selecting a fraction from the entire native or digested biological sample(s) on the basis of pi-value, said fraction comprising native or digested sample representing a subset of or the entire substance population in the sample; b) separating native or digested sample substances from each other; and c) analysing said substances by mass spectrometry. The invention also relates to a system for reducing total sample complexity in the above method, comprising a high capacity charge-selective column coupled to a MDLC work flow path comprising a cation exchange column and a RPC column. The system is followed by a MS/MS instrument.

### TECHNICAL FIELD

The present invention relates to a method and system for reducing total sample complexity in a biological sample before analysing the sample. More closely, the invention relates to reducing total sample complexity in digested biological samples which are going to be analysed by mass spectrometric techniques.

### BACKGROUND

The multidimensional liquid chromatography (MDLC) coupled to ion trap tandem mass spectrometry MS/MS is a powerful tool in proteome characterization. In particular, the “shotgun” proteomics approach has proven to be a promising method due to its ability to analyze the entire proteome, including membrane proteins. The principle is that the entire proteome is transformed to peptides in a controlled manner with enzymatic digestion. Thereafter, the peptides are separated with MDLC, with high peak resolution power, ionized, their mass is measured, the peptides are isolated and fragmented and the mass of the peptide fragments are measured to obtain information about their amino acid sequence. One of the major shortcomings is that once the global proteome, containing thousands of proteins, is digested the sample becomes overwhelmingly complex even for existing MDLC methods. A single sample may contain in the order of 10⁵-10⁷ peptides of different identity, depending of tissue and species.

The reduction of complexity at the peptide level has therefore been given a lot of attention. Several research groups have attempted to improve the utility of mass spectrometry through the use of chemical derivatization techniques. Such techniques have been utilized to promote and direct fragmentation in the MS/MS spectra of peptides with the goal of increasing sensitivity and decreasing the complexity of the resulting spectra. Examples of chemically based methods are described in WO 02/07716 describing the COmbined FRActional DIagonal Chromatographic (COFRADIC) method, and in WO 00/11208 disclosing Isotope Coded Affinity Tags (ICAT) for reducing sample complexity.

In spite of the above, there is still a need for alternative ways of reducing sample complexity within this technical field.

### SUMMARY OF THE INVENTION

The present invention provides a new way to systematically reduce the total complexity of a complex sample, such as the shotgun proteomic sample at the peptide level. In the method of the invention sample complexity is reduced without excluding any representative inherent substances in the sample. An advantage with the method is it enables analysis of low abundant substances in the sample. The method does not need chemical derivatization before the sample reduction.

The present invention also provides a system for sample reduction which may or may not be integrated into a conventional MDLC flow path.

The method and system have the features described in the appended claims.

### BRIEF DESCRIPTION OF THE DRAWINGS

FIG. 1 shows the cumulative distribution of pI for tryptic peptides of five arbitrarily selected proteins (SwissProt accession numbers: P10904 Glycerol-3-phosphate-binding protein, P02769 BSA, P04475 heat shock protein, Q91X72 hemopexin, P97798 neogenin). The presently preferred pH range is indicated in the graph. The pI values for the peptides from theoretical digestion of protein sequences were calculated with the GPMAW software (Lighthouse data, Denmark).

FIG. 2 shows an overview of a presently preferred system of the invention incorporating an existing MDLC flow path.

FIG. 3 shows experimental data supporting the present invention that peptides with similar pI are possible to separate on a cation exchange column at a lower pH than the pH range used in FIG. 1.

FIG. 4a shows distribution of the two properties hydrophobicity and molecular weight, expressed as RPC retention time and ionization mass, among the theoretically extracted peptides of the example protein set.

FIG. 4b shows that correlation between the two properties occurs also in the full set of peptides of the example protein set.

### DETAILED DESCRIPTION OF THE INVENTION

Thus, in a first aspect the invention relates to a method for reducing total sample complexity in native or digested biological sample(s), before analysis thereof by mass spectrometry, comprising the following steps:

a) selecting a fraction from the entire native or digested biological sample(s) on the basis of pI-value, said fraction comprising native or digested sample representing a subset of or the entire substance population in the sample;

b) separating the native or digested sample substances from each other; and

c) analysing said substances by mass spectrometry.

Preferably, said substances are peptides obtained from a protein sample. Preferably the proteins have been enzymatically digested, such as by trypsin, to peptides. Alternatively the biological sample is selected from carbohydrates or nucleic acids which have been digested or otherwise cleaved or fragmented to smaller portions.

According to the invention, the pI-value in step a) is 3.5-4.5 or a sub range thereof. Examples of sub ranges are 3.5-4.0, 4.0-4.5, 3.7-4.2. In a preferred embodiment of the invention, the fraction in step a) is obtained by anion exchange chromatography. Examples are HiTrap Q HP, HiTrap Q FF or Mono Q (all from Amersham Biosciences AB).

The separation in step b) is by cation exchange chromatography. Examples are BioBasic SCX (ThermoHypersil) or MiniS (Amersham Biosciences AB).

According to a preferred embodiment of the present invention, anion exchange chromatography is used in combination with cation exchange chromatography for sample reduction of proteins digested to peptides. The anion exchange step serves to eliminate all peptides except a fraction having a specified pI (pH at which charge is zero) range. The cation exchange step serves to separate the peptide fraction obtained from the anion exchange step.

The present inventors have realized that peptides with the same pI value can be separated on a cation exchanger, preferably a strong cation exhanger, such as PolySULFOETHYL aspartamide SCX, or BioBasic SCX.

In a preferred embodiment, the sample is dissolved in a buffer with pH 4.5 and the sample is loaded onto an anion exchange column. All peptides with higher pI than 4.5 will be positively charged at pH 4.5 and will be repulsed by the positively charged anion exchanger and are discarded. The desired peptides are eluted in a buffer with pH 3.5. In this way, peptides are obtained with pI-values between 3.5 and 4.5.

In one embodiment, the anion exchange column is coupled to the cation exchange column. Alternatively this may be a separate unit. Preferably, the pH in step a) is higher than in step b).

The present invention is suitable for any type of MS analysis, preferably tandem MS. The MS may be ESI (electrospray ionisation)-MS or MALDI (matrix assisted laser desorption ionisation)-MS.

The MS analysis might be run directly after the cation exchange step in step b) or be integrated in a conventional MDLC (multi dimensional liquid chromatography) step comprising cation exchange chromatography (which may be the same as in step b)), RPC (reverse phase chromatography) and MS/MS. Preferably the MS/MS is ESI MS/MS.

The fraction selected in step a) may also be obtained by isoelectric focussing (IEF) or chromatofocussing.

In case of isoelectric focussing, it may be run in an IEF gel or liquid IEF column, such as Rotafor. In case of a gel, the peptides in the band representing pI 3.5-4.5 (or a more narrow sub range) are removed from the gel or strip and further processed to run the subsequent cation exchange chromatography.

In case of chromatofocussing the column, such as a MonoP column (Amersham Biosciences AB), can be integrated with a cation exchange column (such as described above for the anion exchanger) or can be a separate unit. Examples of buffers for the chromatofocussing column is Polybuffer 74 and piperazine pH 5.5.

The present method may also be used for differential quantification of two or more samples. In that case the biological sample(s) comprises two or more samples which are differentially labelled. The labelling may be isotopic or any other labelling which is known in the art. For example, one sample may contain a heavy reagent, for example deuterated, and the other sample a light reagent. The labelling may be done at any stage in the process but preferably before step a) which avoids separate runs.

In second aspect, the invention relates to a system or device for reducing total sample complexity in the above method. The system comprises a charge-selective column coupled to a MDLC work flow path comprising a cation exchange column and a RPC column. Preferably, the charge-selective column is coupled to the cation column via a waste outlet. The system according to the invention ending with a RPC column is in turn followed by a MS/MS instrument.

The charge-selective column may be an anion exchange column, a chromatofocussing column, or IEF column. The charge-selective column preferably has high loading capacity. The charge-selective column together with appropriate buffers enables selection of desired substances on the basis of pI-value.

In case of an anion exchange column, the system also comprises a first buffer of pH 4.5-4.0 and a second buffer of pH 4.0-3.5, wherein the second buffer has a lower pH than the first buffer. Preferably the anion exchanger is run with a buffer of pH 4.5 and eluted with a buffer of pH 3.5. In case of a chromatofocussing column, the buffers are for example those described above in connection with the first aspect of the invention. In case of an IEF column, such as Rotafor, conventional buffers are used.

The cation exchange column is run with a buffer of lower pH than the one used for elution from the charge-selective column, i.e. the pH should be lower than pH 3.0, preferably pH 2.0.

A presently preferred system comprises, besides conventional pump and valves etc.:

Anion exchange column=HiTrap Q HP

Cation exchange column=BioBasic SCX

RPC=Zorbax SB300 <100 μm i.d

Preferably the system is used with ESI MS/MS, such as ThermoElectron LTQ.

Definitions

Biological sample means any biological sample, i.e. it can be derived from body fluid or tissue sample.

Digested sample means an enzymatically, chemically or mechanically cleaved sample.

Total sample complexity reduction means a reduction from a large number of substances to a small fraction substances still representing the entire substance population.

Example

This example is described in relation to peptides but it is to be understood that any substances capable of being selected by pI might be used in the method of the invention. Therefore, the example should be construed as non-limiting for the scope of the claims as defined in the appended claims.

A. Selective Sample Reduction

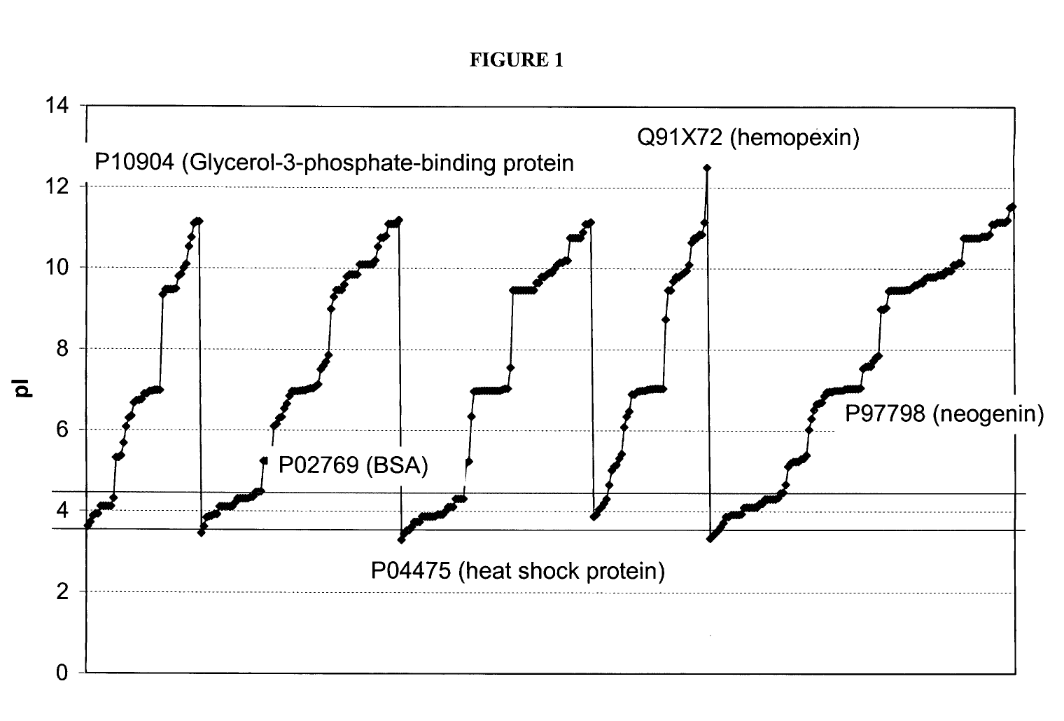

A sample comprising digested peptides of a protein sample is dissolved in a buffer with pH 4.5. Thereafter, the sample is loaded onto an anion exchange column, preferably a high capacity anion exchange column, such as HiTrap Q HP (Amersham Biosciences), and the column is run with this pH 4.5 buffer for about 2-3 column volumes. All peptides with pI higher than 4.5 will be positively charged and will not adhere to the column and are sent to waste. Thereafter the peptides are eluted in a small amount of buffer at pH 3.5. The peptides with pI above 3.5 will now be positively charged and elute off the anion exchange column (FIG. 1).

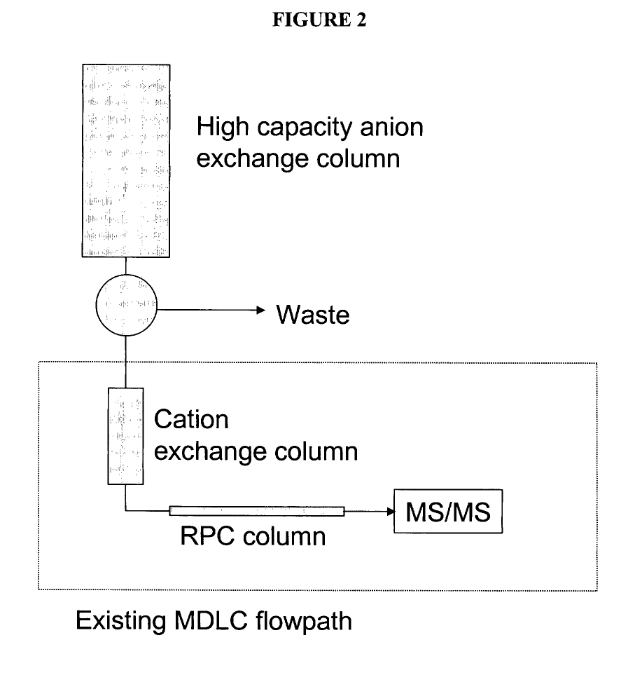

The eluate from the anion column is collected on a cation exchange column, where the desired peptides are trapped. The cation exchange column may be the same column as will be used for the subsequent MDLC run (FIG. 2), such as a BioBasic SCX. The peptides trapped on the cation exchange column are now only a small fraction of the entire population but a few from each protein are there (FIG. 1). The selected pH range 3.5-4.5 gives easily ionized peptides in a heterogeneous group and in sufficient number to allow optimal MS/MS analysis. This range pH 3.5-4.5 might be further narrowed for increase of sensitivity, such as pH 3.7-4.2.

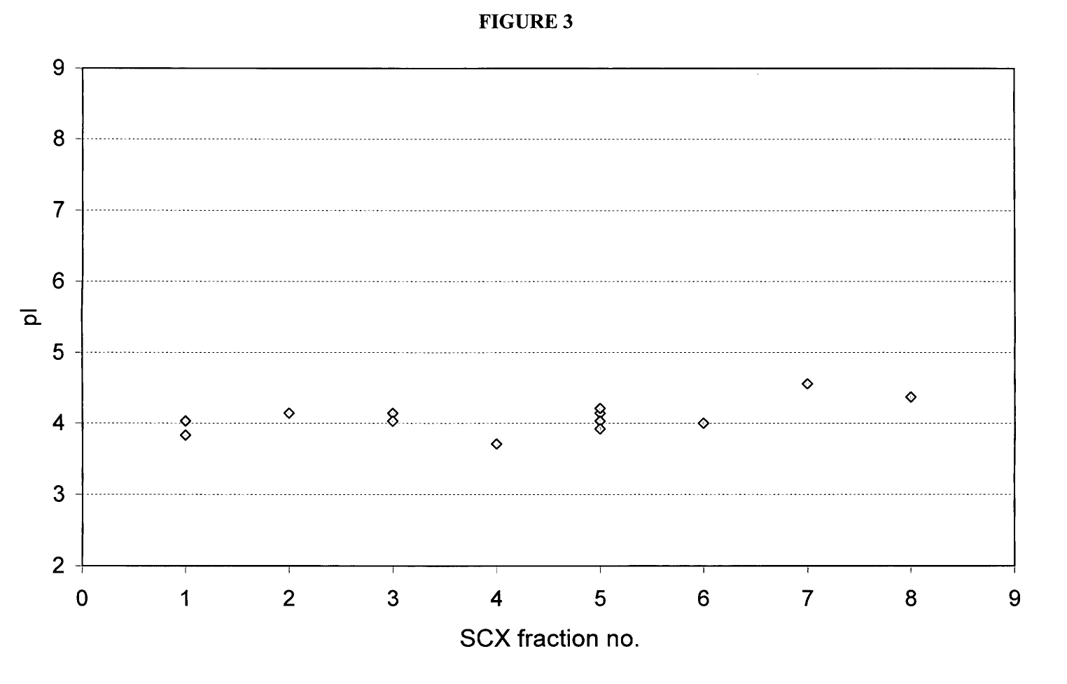

The next step is to change to a low pH buffer (for example pH 2.0), at which the charge of the peptides will change. The titration curve of each peptide is unique and has different slopes, hence the charge at pH 2 will differ among the peptides that all were neutral around pH 4. In FIG. 3, a limited set of experimental data supports this assumption. It is clearly shown that peptides with similar pI are possible to separate on a cation exchange column at a low pH.

B. MDLC Separation

Thereafter, the existing 2DLC (MDLC) workflow can start directly when the peptides are already loaded on the cation column (FIG. 2). In a preferred embodiment a new system is provided in which the anion exchange column is integrated into a conventional MDLC system, i.e. a system comprising a cation exchange column, a RPC column and conventional pumps and valves etc.

In an alternative embodiment, the anion exchange elution and cation exchange trapping/separation could be done separately from the MDLC system.

In FIG. 3, experimental data are showed supporting the present invention that peptides with similar pI are possible to separate on a cation exchange column at a lower pH than the pH range used in FIG. 1. Fraction 1-8 corresponds to the interval 0 to 70% B, during which approximately 90% of the peptides elute. All peptides in the graph have a pI in the interval 3.5-4.5. The sample was mouse plasma and the column was PolySULFOETHYL aspartamide SCX. pH was 2.65. The pI values were calculated by the TurboSEQUEST MS/MS peptide and protein identification software (Thermo Electron, USA).

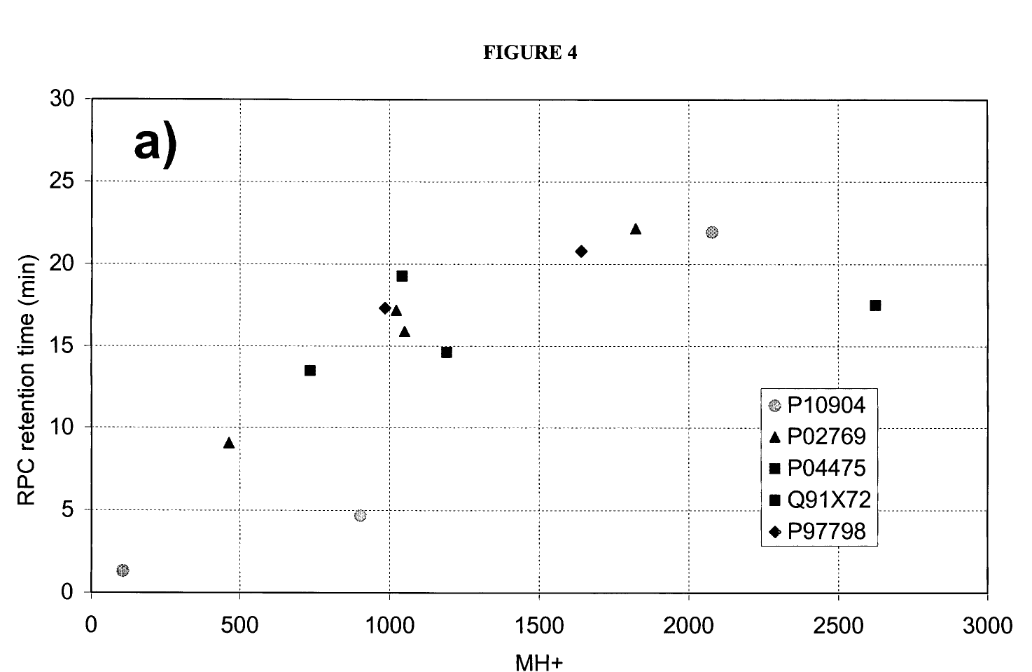

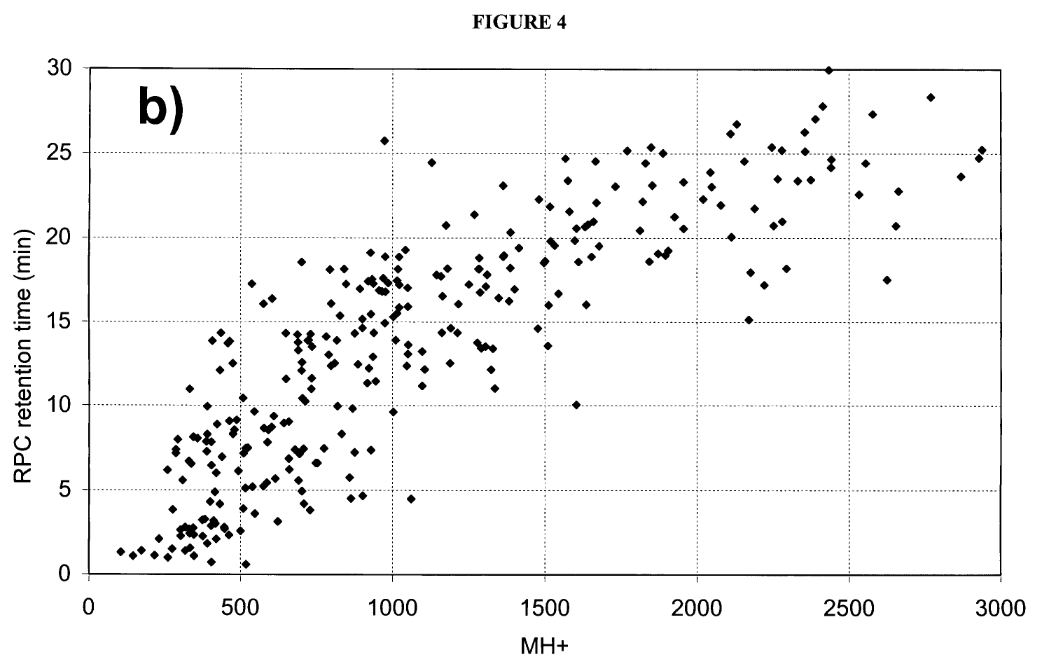

The extracted subset of peptides appears to be a random set with a good distribution in mass and RPC retention time (FIG. 4), which makes them suitable for the 2D LC workflow.

An important advantage of the invention is that the reduction of complexity has the ability to increase the overall sensitivity of the MDLC (or MALDI) approach. A limiting factor for the ability to analyze low abundant proteins is that the loading capacity of the 1^{st} dimension column is limited. In the typical existing MDLC set up this capacity corresponds to less than 1 mg of total protein.

According to the present invention, a column with high capacity is used for the first step (anion exchange), at which 80% of the material is removed, the potential increase in sensitivity for the application is equal to the degree of complexity reduction. This means approximately a factor 5. Thus, the sample concentration has in this case increased by a factor 5 and this means that low abundant proteins are more easily discovered than in a dilute sample.

The sample complexity reduction may be more than 80%, such as 95%, if the pH interval 3.5-4.5 is further narrowed as explained above.

1: A method for reducing total sample complexity in native or digested biological sample(s), before analysis thereof by mass spectrometry, comprising the following steps:
a) selecting a fraction from the entire native or digested biological sample(s) on the basis of pI-value, said fraction comprising native or digested sample representing the entire substance population in the sample;
b) separating native or digested sample substances from each other; and
c) analysing said substances by mass spectrometry.

2: The method of claim 1, wherein said substances are peptides obtained from proteins in the sample(s).

3: The method of claim 1, wherein the pI-value is 3.5-4.5 or a sub range thereof.

4: The method of claim 1, wherein the pI-value is selected to target one or more specific peptides.

5: The method of claim 1, wherein said fraction in step a) is obtained by anion exchange chromatography.

6: The method of claim 5, wherein the separation in step b) is by cation exchange chromatography.

7: The method of claim 1, wherein, in step a), the sample is dissolved in a buffer with pH 4.5, the sample is loaded onto an anion exchange column, and the desired peptides are eluted in a buffer with pH 3.5.

8: The method of claim 1, wherein the separation in step b) is by multidimensional chromatography, MDLC, comprising cation exchange chromatography, RPC (reverse phase chromatography) and MS/MS.

9: The method of claim 6, wherein the anion exchange column is coupled to the cation exchange column.

10: The method of claim 9, wherein the pH in step a) is higher than in step b).

11: The method of claim 1, wherein the fraction in step a) is obtained by isoelectric focussing.

12: The method of claim 1, wherein the fraction in step a) is obtained by chromatofocussing.

13: The method of claim 11, which is integrated to a conventional MDLC (multidimensional liquid chromatography) flow path.

14: The method of claim 1, wherein the mass spectrometric analysis is tandem MS.

15: The method of claim 1 wherein the MS is ESI (electrospray ionisation)-MS.

16: The method of claim 1 wherein the MS is MALDI (matrix assisted laser desorption ionisation)-MS.

17: The method of claim 1 wherein the biological sample(s) comprises at least two samples which are differentially labelled.

18: A system for reducing total sample complexity comprising a charge-selective column coupled to a MDLC work flow path comprising a cation exchange column and a RPC column.

19: The system of claim 18, wherein the charge-selective column is an anion exchange column.

20: The system of claim 18, wherein the charge-selective column is run with a first buffer having pH 4.5-4.0 and a second buffer having pH 3.5-4.0, wherein the second buffer has lower pH than the first buffer and is used for elution.

21: The system of claim 18, wherein the charge-selective column is a chromatofocussing column.

22: The system of claim 18, wherein the charge-selective column in an isoelectric focussing column.

23: The system of claim 20, wherein the cation exchange column is run with a third buffer with pH lower than the buffer used for elution from the charge-selective column.

24: The method of claim 12, which is integrated to a conventional MDLC (multidimensional liquid chromatography) flow path.
